(19) United States
(12) Patent Application Publication
(10) Pub. No.: US 2016/0341993 A1
(43) Pub. Date: Nov. 24, 2016

(54) LC PANEL, A MANUFACTURING METHOD THEREOF AND AN LCD

(71) Applicant: Shenzhen China Star Optoelectronics Technology Co., Ltd., Shenzhen, Guangdong (CN)

(72) Inventor: Yuejun TANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/435,709

(22) PCT Filed: Jan. 14, 2015
(86) PCT No.: PCT/CN2015/070669

§ 371 Date: Apr. 14, 2015

(30) Foreign Application Priority Data
Dec. 30, 2014 (CN) 201410849130.2

(51) Int. Cl. G02F 1/1339; G02F 1/1341; G02F 1/1335

(52) U.S. Cl. CPC G02F 1/1339; G02F 1/133514; G02F 1/1341; G02F 2001/13398

(57) ABSTRACT

The present invention provides an LC panel includes a first substrate, a second substrate opposite to the first substrate, an LC layer clamped between the first substrate and the second substrate, and a sealant to seal the LC layer between the first substrate and the second substrate. The location of the LC layer surrounded by the sealant is the displaying region of the LC panel, wherein a spherical supporter is arranged in the sealant. The spherical supporter includes an inner layer and an outer layer. One of the inner layer and the outer layer is made of the thermal expansive material, or both the inner layer and the outer layer are made of the thermal expansive materials. The present invention provides a method of manufacturing an LC panel and an LCD.

### CROSS REFERENCE TO RELATED APPLICATIONS

The present invention claims the right of priority based on China Patent Application No. 201410849130.2 entitled “LC Panel, A Manufacturing Method Thereof and An LCD”, filed on Dec. 30, 2014, which is incorporated herein by reference.

### BACKGROUND

1. Technical Field

The present invention relates to a liquid crystal (LC) panel, a manufacturing method thereof, and a liquid crystal display (LCD).

2. Description of the Related Art

A liquid crystal display (LCD) as a display of electronic devices has been adopted in various electronic products. The LCD includes an array substrate, a color filter (CF) substrate opposite to the array substrate, and liquid crystal (LC) therebetween. A sealant to seal the LC and a supporter are formed between the array substrate and the CF substrate. A displaying region, a transitional region surrounding the displaying region, and the sealant surrounding the transitional region are formed therefore. In the manufacturing process, metal leads are formed on the top and the bottom of the sealant. The nonuniform of the metal leads causes the nonuniform of the dimension of the sealant so the gap between the array substrate and the CF substrate of the transitional region is reduced. That is, deformation of the glass layer of the array substrate or the CF substrate toward the LC is performed and color shift of single side or multiple sides on the periphery of the displaying region are generated. The displaying quality of the displaying region is influenced seriously.

### SUMMARY OF THE DISCLOSURE

The present invention is to provide an LC panel to improve color shift of the LC panel, ensuring the displaying quality of the displaying region.

The present invention also provides a manufacturing method of an LC panel, and an LCD.

An LC panel includes a first substrate, a second substrate opposite to the first substrate, an LC layer clamped between the first substrate and the second substrate, and a sealant to seal the LC layer between the first substrate and the second substrate. The location of the LC layer surrounded by the sealant is a displaying region of the LC panel, wherein a spherical supporter is arranged in the sealant. The spherical supporter includes an inner layer and an outer layer. One of the inner layer and the outer layer is made of the thermal expansive material, or both the inner layer and the outer layer are made of the thermal expansive materials.

The section of the sealant is rectangular of which height is 2-10 μm and width is 50-3000 μm.

The diameter of the spherical supporter is 2-10 μm.

The thermal expansive material is a photo-thermal sensitive material including the heat-shrinkable polyester. The heat-shrinkable polyester can be Poly Lactic Acid (PLA) series compound or polysiloxane acrylic acid series compound.

The thermoplastic resin includes one of fluoride compound, tetraalkylsilane, and azodiformamide.

One of the inner layer and the outer layer is made of the thermal expansive material and the other one is made of silicon dioxide material.

A portion of the spherical supporter made of the thermal expansive material is deformed after the spherical supporter is heated via lighting. The time, the temperature, and the area of lighting are predetermined.

The first substrate is an array substrate and the second substrate is a CF substrate; or the first substrate is a CF substrate and the second substrate is an array substrate.

The present invention also provides an LCD includes an LC panel. The LC panel includes a first substrate, a second substrate opposite to the first substrate, an LC layer clamped between the first substrate and the second substrate, and a sealant to seal the LC layer between the first substrate and the second substrate. The location of the LC layer surrounded by the sealant is a displaying region of the LC panel, wherein a spherical supporter is arranged in the sealant. The spherical supporter includes an inner layer and an outer layer. One of the inner layer and the outer layer is made of the thermal expansive material, or both the inner layer and the outer layer are made of the thermal expansive materials.

The section of the sealant is rectangular of which height is 2-10 μm and width is 50-3000 μm.

The diameter of the spherical supporter is 2-10 μm.

The thermal expansive material is a photo-thermal sensitive foam material including thermoplastic resin.

The thermoplastic resin includes one of fluoride compound, tetraalkylsilane, and azodiformamide.

One of the inner layer and the outer layer is made of the thermal expansive material and the other one is made of silicon dioxide material.

A portion of the spherical supporter made of the thermal expansive material is deformed after the spherical supporter is heated via lighting. The time, the temperature, and the area of lighting are predetermined.

The first substrate is an array substrate and the second substrate is a CF substrate; or the first substrate is a CF substrate and the second substrate is an array substrate.

The present invention also provides a method of manufacturing an LC panel including providing a first substrate, a second substrate opposite to the first substrate; forming a sealant between the first substrate and the second substrate, wherein a spherical supporter is arranged in the sealant, the spherical supporter includes an inner layer and an outer layer, and one of the inner layer and the outer layer is made of the thermal expansive material, or both the inner layer and the outer layer are made of the thermal expansive materials; curing the spherical supporter and the sealant that is not cured simultaneously; and filling LC between the first substrate and the second substrate and in the sealant, wherein the location of the LC is a displaying region.

The spherical supporter made of a thermal expansive material is arranged in the sealant which is on the peripheral of the LC panel and connected with the array substrate or the CF substrate. The spherical supporter is heated via lighting and becomes tall. Adjusting the gap between the array substrate and the CF substrate is performed and the color shift at the peripheral of the LC panel is reduced. The displaying quality of the LC panel is therefore improved.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a top view of a portion of an LC panel in accordance with the first embodiment of the present invention.

FIG. 2 is a side view of the LC panel of FIG. 1, wherein the outer layer of is made of a thermal expansive material.

FIG. 3 is a side view of the LC panel of FIG. 1, wherein both the outer layer and the inner layer of the spherical supporter are made of thermal expansive materials.

### DESCRIPTION OF THE PREFERRED EMBODIMENT

To better and concisely explain the disclosure, the same name or the same reference number given or appeared in different paragraphs or figures along the specification should has the same or equivalent meanings while it is once defined anywhere of the disclosure.

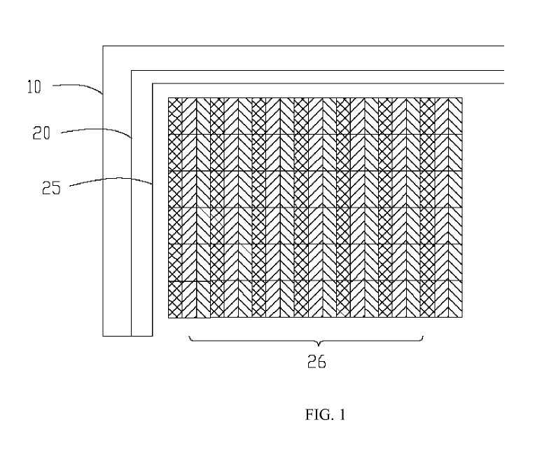

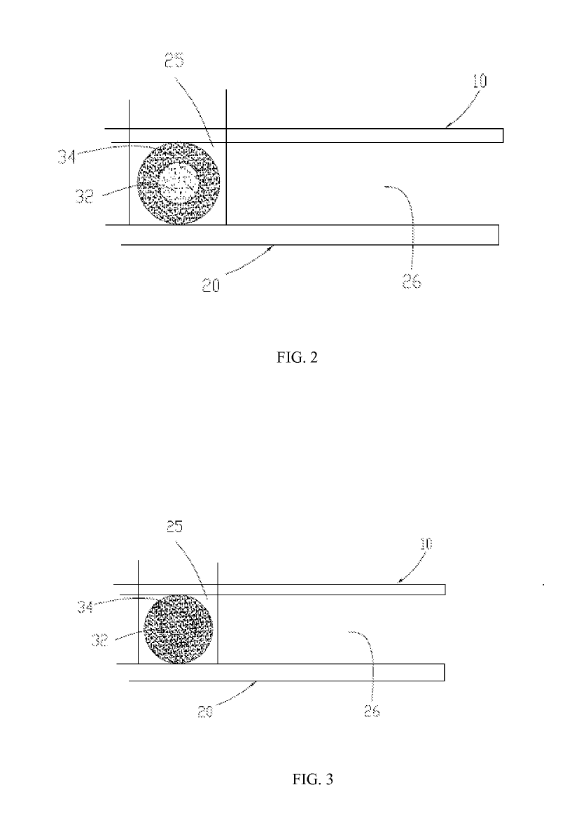

Referring to FIGS. 1 and 2, an LC panel includes a first substrate 10, a second substrate 20 opposite to the first substrate 10, an LC layer clamped between the first substrate 10 and the second substrate 20, and a sealant 25 to seal the LC layer between the first substrate 10 and the second substrate 20. The location of the LC layer surrounded by the sealant 25 is a displaying region 26 of the LC panel, wherein a spherical supporter 30 is arranged in the sealant 25. The spherical supporter 30 includes an inner layer 32 and an outer layer 34. One of the inner layer 32 and the outer layer 34 is made of a thermal expansive material, or both the inner layer 32 and the outer layer 34 are made of the thermal expansive materials.

Further, the first substrate 10 is an array substrate and the second substrate 20 is a CF substrate, or the first substrate 10 is a CF substrate and the second substrate 20 is an array substrate. In this embodiment, it exemplifies that the first substrate 10 is an array substrate and the second substrate 20 is a CF substrate on a margin region of the LC panel, and the sealant 25 is located on the non-displaying region of the LC panel.

Further, the section of the sealant 25 is rectangular of which height is 2-10 μm and width is 50-30001 μm.

Further, the diameter of the spherical supporter 30 is 2-10 μm.

Further, the thermal expansive material is a photo-thermal sensitive foam material including thermoplastic resin. The thermoplastic resin includes one of fluoride compound, tetraalkylsilane, and azodiformamide, and the shrinkage temperature thereof is at least 130° C. The lighting temperature that the spherical supporter 30 needs is larger than the temperature of the sequential process after the sealant 25 is formed. Laser is specifically utilized to light the portion that the spherical supporter 30 needs so the change of the dimension of the silicon ball in the lighting region is ensured.

Further, a portion of the spherical supporter 30 made of the thermal expansive material is deformed after the spherical supporter 30 is heated via lighting. The time, the temperature, and the area of lighting are predetermined.

In this embodiment, one of the outer layer 34 and the inner layer 32 is made of the thermal expansive material and the other one is made of silicon dioxide material. Specifically, the outer layer 34 is made of the thermal expansive material and the inner layer 32 is made of silicon dioxide material. Otherwise, the outer layer 34 is made of silicon dioxide material and the inner layer 32 is made of the thermal expansive material

When the dimension of the sealant 25 becomes small, deformation on the single side, the multiple sides, or somewhere of the array substrate 10 or the CF substrate 20 is formed and the gap between the array substrate 10 and the CF substrate 20 becomes small. The spherical supporter 30 located on the deformed position is heated via laser lighting and the outer layer 34 or the inner layer 32 expands because of heating. The height of the spherical supporter 30 becomes large and the sealant 25 has enough supporting height so the gap between the array substrate 10 and the CF substrate 20 is ensured and the color shift of the LC panel is improved. The composition of the thermal expansive material and the volume occupation ratio of the spherical supporter 30 can be adjusted. The time, the temperature, and the area of the spherical supporter 30 for heating can be predetermined according to the specific situation to effectively prevent the damage of the LC panel.

Referring to FIG. 3, both the outer layer 34 and the inner layer 32 are made of the thermal expansive material in another embodiment.

When the dimension of the sealant 25 becomes small, deformation on the single side, the multiple sides, or somewhere of the array substrate 10 or the CF substrate 20 is formed and the gap between the array substrate 10 and the CF substrate 20 becomes small. The spherical supporter 30 located on the deformed position is heated via laser lighting, and the outer layer 34 and the inner layer 32 expands because of heating. The height of the spherical supporter 30 becomes large and the sealant 25 has enough supporting height so the deformation at the array substrate 10 and the CF substrate 20 is reduced. The gap between the array substrate 10 and the CF substrate 20 is ensured and the color shift at the periphery of the LC panel is improved. The time, the temperature, and the area of the spherical supporter 30 for heating can be predetermined according to the specific situation to effectively prevent the damage of the LC panel.

The present invention also provides an LCD including the aforementioned LC panel.

The present invention also provides a method of manufacturing the aforementioned LC panel including providing a first substrate, a second substrate opposite to the first substrate; forming a sealant between the first substrate and the second substrate, wherein a spherical supporter is arranged in the sealant, the spherical supporter includes an inner layer and an outer layer, and one of the inner layer and the outer layer is made of the thermal expansive material, or both the inner layer and the outer layer are made of the thermal expansive materials; curing the spherical supporter and the sealant that is not cured simultaneously; and filling LC between the first substrate and the second substrate and in the sealant, wherein the location of the LC is a displaying region. The method of filling LC is one drop filling (ODF).

Further, laser lighting to the sealant can be utilized in any phase of the curing to change the dimension of the spherical supporter such as before the curing, during the curing, and after the curing. Particularly, in the process of curing the spherical supporter, the spherical supporter of which dimension is not in the predetermined range is lighted to change the dimension. For instance, some portions of the cured sealant have deformation and the deformed spherical supporters are lighted so color shift at the periphery of the LC panel can be improved during the manufacturing process.

The spherical supporter made of a thermal expansive material is arranged in the sealant which is on the peripheral of the LC panel and connected with the array substrate or the CF substrate. The spherical supporter is heated via lighting and expands to ensure that the sealant has enough dimension to support the deformed substrate. The gap between the array substrate and the CF substrate is ensured and the color shift at the peripheral of the LC panel is improved. The displaying quality of the LC panel is therefore promoted.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. An LC panel, comprising:
a first substrate;
a second substrate opposite to the first substrate;
an LC layer clamped between the first substrate and the second substrate; and
a sealant between the first substrate and the second substrate, sealing the LC layer;
wherein a location of the LC layer surrounded by the sealant is a displaying region of the LC panel,
wherein a spherical supporter is arranged in the sealant, the spherical supporter comprises an inner layer and an outer layer, wherein one of the inner layer and the outer layer is made of a thermal expansive material, or both the inner layer and the outer layer are made of the thermal expansive materials.

2. The LC panel of claim 1, wherein a section of the sealant is rectangular of which height is 2-10 μm and width is 50-3000 μm.

3. The LC panel of claim 2, wherein a diameter of the spherical supporter is 2-0 μm.

4. The LC panel of claim 3, wherein the thermal expansive material comprises a photo-thermal sensitive foam comprising thermoplastic resin.

5. The LC panel of claim 4, wherein the thermoplastic resin is selected from a group consisting of fluoride compound, tetraalkylsilane, and azodiformamide.

6. The LC panel of claim 1, wherein one of the inner layer and the outer layer is made of the thermal expansive material and the other one is made of a silicon dioxide material.

7. The LC panel of claim 1, wherein a portion of the spherical supporter made of the thermal expansive material is deformed after the spherical supporter is heated via lighting, and time, temperature, and area of lighting are predetermined.

8. The LC panel of claim 1, wherein the first substrate is an array substrate and the second substrate is a CF substrate, or the first substrate is a CF substrate and the second substrate is an array substrate.

9. An LCD, comprising:
an LC panel, comprising:
a first substrate;
a second substrate opposite to the first substrate;
an LC layer clamped between the first substrate and the second substrate; and
a sealant between the first substrate and the second substrate, sealing the LC layer;
wherein a location of the LC layer surrounded by the sealant is a displaying region of the LC panel,
wherein a spherical supporter is arranged in the sealant, the spherical supporter comprises an inner layer and an outer layer, wherein one of the inner layer and the outer layer is made of a thermal expansive material, or both the inner layer and the outer layer are made of the thermal expansive materials.

10. The LCD of claim 9, wherein a section of the sealant is rectangular of which height is 2-10 μm and width is 50-3000 μm.

11. The LCD of claim 10, wherein a diameter of the spherical supporter is 2-10 μm.

12. The LCD of claim 11, wherein the thermal expansive material comprises a photo-thermal sensitive foam comprising thermoplastic resin.

13. The LCD of claim 12, wherein the thermoplastic resin is selected from a group consisting of fluoride compound, tetraalkylsilane, and azodiformamide.

14. The LCD of claim 9, wherein one of the inner layer and the outer layer is made of the thermal expansive material and the other one is made of a silicon dioxide material.

15. The LCD of claim 9, wherein a portion of the spherical supporter made of the thermal expansive material is deformed after the spherical supporter is heated via lighting, and time, temperature, and area of lighting are predetermined.

16. The LCD of claim 9, wherein the first substrate is an array substrate and the second substrate is a CF substrate, or the first substrate is a CF substrate and the second substrate is an array substrate.

17. A method of manufacturing an LC panel comprising:
providing a first substrate, a second substrate opposite to the first substrate;
forming a sealant between the first substrate and the second substrate, wherein a spherical supporter is arranged in the sealant, the spherical supporter comprises an inner layer and an outer layer, and one of the inner layer and the outer layer is made of the thermal expansive material, or both the inner layer and the outer layer are made of the thermal expansive materials;
curing the spherical supporter and the sealant that is not cured simultaneously; and
filling LC between the first substrate and the second substrate and in the sealant, wherein the location of the LC is a displaying region.
